(19) United States
(12) Patent Application Publication
(10) Pub. No.: US 2016/0326909 A1
(43) Pub. Date: Nov. 10, 2016

(54) GAS TURBINE ENGINE COMPONENT WITH SEPARATION RIB FOR COOLING PASSAGES

(71) Applicant: UNITED TECHNOLOGIES CORPORATION, Farmington, CT (US)

(72) Inventors: Charles Thistle, Middletown, CT (US); Lane Thornton, Meriden, CT (US)

(21) Appl. No.: 15/111,517

(22) PCT Filed: Jan. 21, 2015
(86) PCT No.: PCT/US2015/012119

§ 371 Date: Jul. 14, 2016

Related U.S. Application Data
(60) Provisional application No. 61/939,307, filed on Feb. 13, 2014.

(51) Int. Cl. F01D 25/12; F01D 11/08; F02C 7/12; F01D 5/18; F02C 3/10; F02K 3/06

(52) U.S. Cl. CPC F01D 25/12; F02C 3/10; F02K 3/06; F02C 7/12; F01D 5/187; F01D 11/08; F05D 2250/11

(57) ABSTRACT

A gas turbine engine component comprises a body extending between two ends and having at least two cooling passages. The body has a first wall and second wall. At least two cooling passages include a first passage that is closer to the first wall than is a second of the passages at upstream locations along a flow path. The second passage has upstream locations that are closer to the second wall than are upstream portions of the first passage. The first and second passages cross along a length of the flow path such that downstream portions of the second passage are closer to the first wall than are downstream portions of the first passage, and downstream portions of the first passage are closer to the second wall than are downstream portions of the second passage.

### CROSS-REFERENCE TO RELATED APPLICATION

This application claims priority to U.S. Provisional Patent Application No. 61/939,307, filed Feb. 13, 2014.

### BACKGROUND OF THE INVENTION

This application relates to the provision of cooling passages in gas turbine engine components.

Gas turbine engines are known and, typically, include a compressor compressing air and delivering it into a combustion section where it is mixed with fuel and ignited. Products of this combustion pass downstream over turbine rotors driving them to rotate. There are typically static vane stages intermediate rows of turbine blades in the turbine section. In addition, there are often blade outer air seals positioned radially outwardly of the turbine blades.

All of the components in the turbine section experience very high temperatures. Thus, it is known to provide cooling air to the components. The components do not face uniform heat across their entire outer surface. It is often the case that one wall will be subject to much higher heat than an opposed wall.

As the cooling air passes along an axial length of the component, it takes in heat and becomes hotter. In the prior art, cooling air passages provided adjacent a hot exterior wall have air that becomes much hotter at a downstream end of the component than does air, for example, which may be passing along a cooler exterior wall.

### SUMMARY OF THE INVENTION

In a featured embodiment, a gas turbine engine component comprises a body extending between two ends and having at least two cooling passages. The body has a first wall and second wall. At least two cooling passages include a first passage that is closer to the first wall than is a second of the passages at upstream locations along a flow path. The second passage has upstream locations that are closer to the second wall than are upstream portions of the first passage. The first and second passages cross along a length of the flow path such that downstream portions of the second passage are closer to the first wall than are downstream portions of the first passage, and downstream portions of the first passage are closer to the second wall than are downstream portions of the second passage.

In another embodiment according to the previous embodiment, one of the first and second walls is exposed to hotter temperature than the other.

In another embodiment according to any of the previous embodiments, the first and second passages have inlets separated by a separating wall at an upstream end.

In another embodiment according to any of the previous embodiments, the first passage begins to move toward the second wall and the second passage begins to move toward the first wall.

In another embodiment according to any of the previous embodiments, the first and second passages have a first triangular location of generally triangular shapes where each of the first and second passages extend to be adjacent each of the first wall and the second wall.

In another embodiment according to any of the previous embodiments, the first and second passages have a second triangular location of generally triangular shapes downstream of the first triangular location.

In another embodiment according to any of the previous embodiments, at a downstream location the second passage extends entirely along the first wall while the first passage extends along the second wall.

In another embodiment according to any of the previous embodiments, at a downstream location the second passage extends entirely along the first wall while the first passage extends along the second wall.

In another embodiment according to any of the previous embodiments, the component includes an airfoil.

In another embodiment according to any of the previous embodiments, the component is a turbine blade.

In another embodiment according to any of the previous embodiments, the component is a blade outer air seal.

In another featured embodiment, a gas turbine engine comprises a turbine section and a compressor section. One of the turbine section and the compressor section includes a component. The component has a body extending between two ends and a pair of cooling passages, the body having a first wall and a second wall. At least two cooling passages include a first passage that is closer to the first wall than is a second of the passages at upstream locations along a flow path. The second passage has upstream locations that are closer to the second wall than are upstream portions of the first passage. The first and second passage cross along a length of the flow path such that downstream portions of the second passage are closer to the first wall than are downstream portions of the first passage, and downstream portions of second passage are closer to the second wall than are downstream portions of the second passage.

In another embodiment according to the previous embodiment, one of the first and second walls is exposed to hotter temperature than the other.

In another embodiment according to any of the previous embodiments, the first and second passages have inlets separated by a separating wall at an upstream end.

In another embodiment according to any of the previous embodiments, the first passage begins to move toward the second wall and the second passage begins to move toward the first wall.

In another embodiment according to any of the previous embodiments, the first and second passages have a first triangular location of generally triangular shapes where each of the first and second passages extend to be adjacent each of the first wall and the second wall.

In another embodiment according to any of the previous embodiments, at a downstream location the second passage extends entirely along the first wall while the first passage extends along the second wall.

In another embodiment according to any of the previous embodiments, the component includes an airfoil.

In another embodiment according to any of the previous embodiments, the component is a turbine blade.

In another embodiment according to any of the previous embodiments, the component is a blade outer air seal.

These and other features may be best understood from the following drawings and specification.

### BRIEF DESCRIPTION OF THE DRAWINGS

FIG. 1 schematically shows a gas turbine engine.

FIG. 2A shows a turbine component.

FIG. 2B shows another turbine component.

FIG. 3 is a view of a pair of cooling passages.

FIG. 4A is a cross-section along line A-A of FIG. 3.

FIG. 4B is a cross-section along line B-B of FIG. 3.

FIG. 4C is a cross-section along line C-C of FIG. 3.

FIG. 4D is a cross-section along line D-D of FIG. 3.

FIG. 4E is a cross-section along line E-E of FIG. 3.

### DETAILED DESCRIPTION

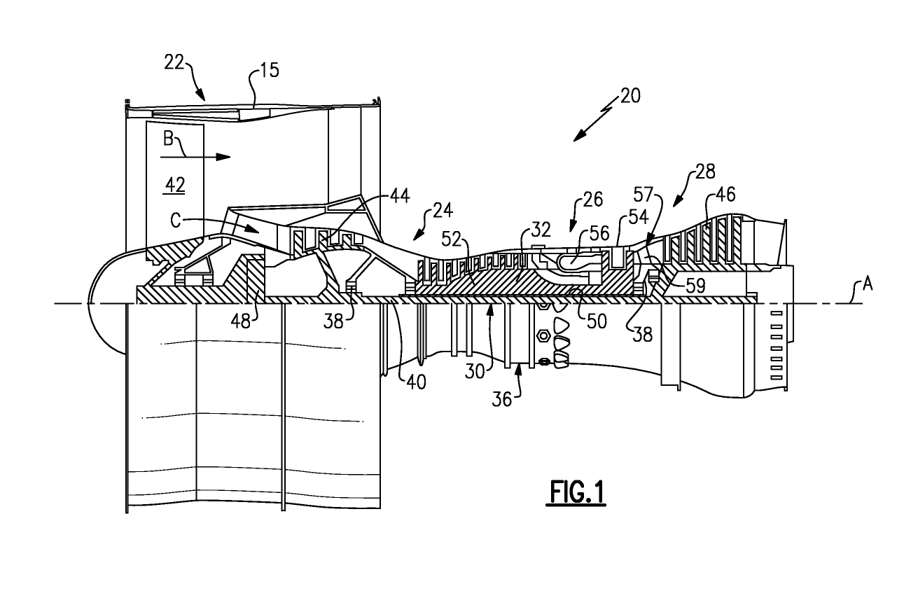

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flow path B in a bypass duct defined within a nacelle 15, while the compressor section 24 drives air along a core flow path C for compression and communication into the combustor section 26 then expansion through the turbine section 28. Although depicted as a two-spool turbofan gas turbine engine in the disclosed non-limiting embodiment, it should be understood that the concepts described herein are not limited to use with two-spool turbofans as the teachings may be applied to other types of turbine engines including three-spool architectures.

The exemplary engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided, and the location of bearing systems 38 may be varied as appropriate to the application.

The low speed spool 30 generally includes an inner shaft 40 that interconnects a fan 42, a first (or low) pressure compressor 44 and a first (or low) pressure turbine 46. The inner shaft 40 is connected to the fan 42 through a speed change mechanism, which in exemplary gas turbine engine 20 is illustrated as a geared architecture 48 to drive the fan 42 at a lower speed than the low speed spool 30. The high speed spool 32 includes an outer shaft 50 that interconnects a second (or high) pressure compressor 52 and a second (or high) pressure turbine 54. A combustor 56 is arranged in exemplary gas turbine 20 between the high pressure compressor 52 and the high pressure turbine 54. A mid-turbine frame 57 of the engine static structure 36 is arranged generally between the high pressure turbine 54 and the low pressure turbine 46. The mid-turbine frame 57 further supports bearing systems 38 in the turbine section 28. The inner shaft 40 and the outer shaft 50 are concentric and rotate via bearing systems 38 about the engine central longitudinal axis A which is collinear with their longitudinal axes.

The core airflow is compressed by the low pressure compressor 44 then the high pressure compressor 52, mixed and burned with fuel in the combustor 56, then expanded over the high pressure turbine 54 and low pressure turbine 46. The mid-turbine frame 57 includes airfoils 59 which are in the core airflow path C. The turbines 46, 54 rotationally drive the respective low speed spool 30 and high speed spool 32 in response to the expansion. It will be appreciated that each of the positions of the fan section 22, compressor section 24, combustor section 26, turbine section 28, and fan drive gear system 48 may be varied. For example, gear system 48 may be located aft of combustor section 26 or even aft of turbine section 28, and fan section 22 may be positioned forward or aft of the location of gear system 48.

The engine 20 in one example is a high-bypass geared aircraft engine. In a further example, the engine 20 bypass ratio is greater than about six (6), with an example embodiment being greater than about ten (10), the geared architecture 48 is an epicyclic gear train, such as a planetary gear system or other gear system, with a gear reduction ratio of greater than about 2.3 and the low pressure turbine 46 has a pressure ratio that is greater than about five. In one disclosed embodiment, the engine 20 bypass ratio is greater than about ten (10:1), the fan diameter is significantly larger than that of the low pressure compressor 44, and the low pressure turbine 46 has a pressure ratio that is greater than about five 5:1. Low pressure turbine 46 pressure ratio is pressure measured prior to inlet of low pressure turbine 46 as related to the pressure at the outlet of the low pressure turbine 46 prior to an exhaust nozzle. The geared architecture 48 may be an epicycle gear train, such as a planetary gear system or other gear system, with a gear reduction ratio of greater than about 2.3:1. It should be understood, however, that the above parameters are only exemplary of one embodiment of a geared architecture engine and that the present invention is applicable to other gas turbine engines including direct drive turbofans.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft, with the engine at its best fuel consumption—also known as “bucket cruise Thrust Specific Fuel Consumption (‘TSFC’)”—is the industry standard parameter of lbm of fuel being burned divided by lbf of thrust the engine produces at that minimum point. “Low fan pressure ratio” is the pressure ratio across the fan blade alone, without a Fan Exit Guide Vane (“FEGV”) system. The low fan pressure ratio as disclosed herein according to one non-limiting embodiment is less than about 1.45. “Low corrected fan tip speed” is the actual fan tip speed in ft/sec divided by an industry standard temperature correction of [(Tram ° R)/(518.7° R)]^{0.5}. The “Low corrected fan tip speed” as disclosed herein according to one non-limiting embodiment is less than about 1150 ft/second.

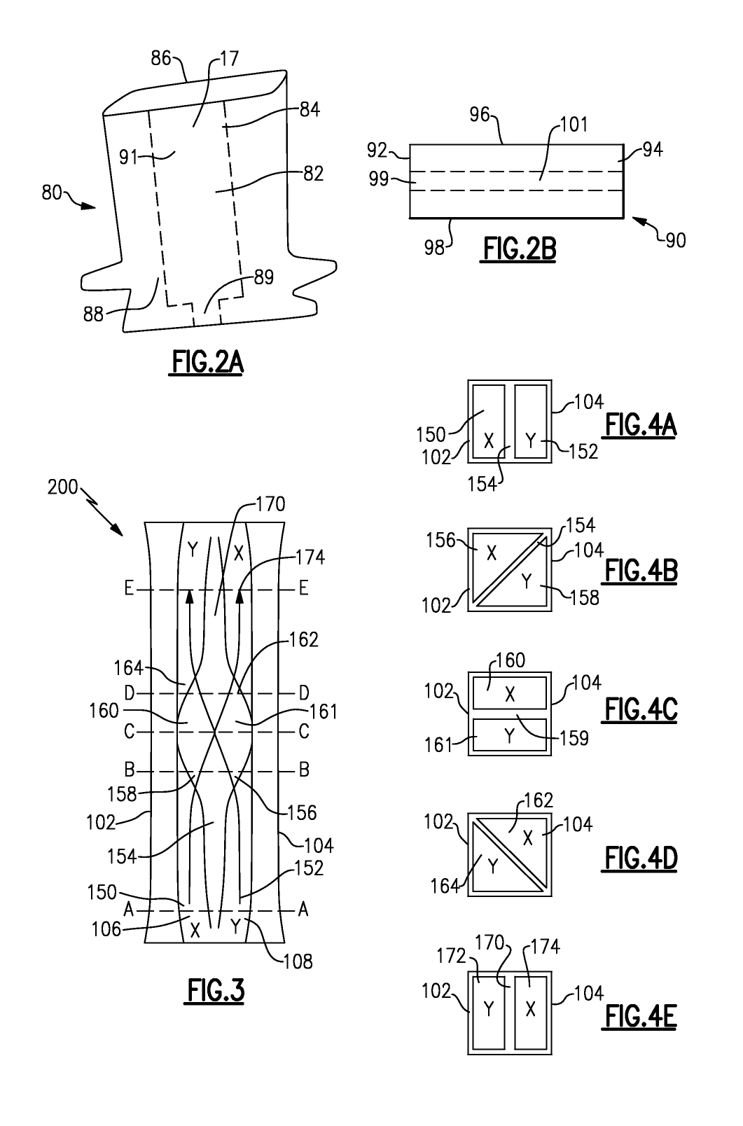

FIG. 2A shows a gas turbine engine component which may be a turbine blade 80 for use in a turbine section in an engine, such as engine 20, as an example. An airfoil 82 extends away from a base or platform 88. As known, air is passed into an inlet 89 adjacent the platform and passes through cooling passages 91 along the length of the airfoil 81 to a downstream end 17. The airfoil 82 has opposed suction and pressure walls 84 and 86. One of the walls may be exposed to higher temperature than the others. Static vanes have similar structure, and would also benefit from the teachings of this disclosure.

FIG. 2B shows a blade outer air seal 90. Again, cooling air may be directed into an inlet 99 and then passed through passages 101 along a length of the blade outer air seal 90, such as from an upstream end 92 to a downstream end 94. The blade outer air seal 90 would typically have an inner wall 98 facing the products of combustion and an outer wall 96 facing away from the products of combustion.

As can be appreciated, in the FIG. 2A turbine blade 80, the cooling air may flow radially, while the airflow in the blade outer air seal 90 would tend to be axial. Both of these directions are taken relative to the centerline of the engine. On the other hand, there may be axial flow within a turbine blade 80 utilizing the teachings of this disclosure.

As can be appreciated, if the cooling air in the passages 91 or 101 is adjacent a hotter of the walls of the blade 80 or blade outer air seal 90, that air will become relatively hot when it reaches a downstream end. On the other hand, if the cooling passages 91 or 101 is adjacent the cooler wall, it will be cooler when it reaches the downstream end.

FIG. 3 discloses a cooling arrangement 200 which may be incorporated into a component, such as shown in FIG. 2A, 2B or other gas turbine engine components requiring cooling air.

As shown, the cooling scheme 200 includes a pair of cooling passages 106 and 108. Passage 106 is associated with flow direction X and path 108 is associated with a flow direction Y. Air passes into an inlet 150 and 152 for the 106 and 108 passages. As is clear, the inlet 150 is closer to a hot exterior wall 102, while the inlet 152 is closer to a cooler exterior wall 104. This is shown in FIG. 4A. Note a separating wall 154 separates the passage inlets 150 and 152.

While the cooler wall 104 may be an exterior wall, it is also within the teachings of this disclosure that the cooler wall 104 be an internal wall, such as may be defined within the interior of an airfoil, or other component.

The air passes downstream cooling the walls 102 and 104. At a point identified by the cross-section B of FIG. 4B, the two passages are now in generally triangular shapes 156 and 158. As can be seen, the passage X that had been inlet 150 now has a portion that is closer to the cool wall 104, while the passage Y that had been associated with the cooler wall 104 is now moving to have a portion adjacent the hot wall 102.

The air continues to move downstream cooling the walls 102 and 104 to the point identified by the cross-section of FIG. 4C. At this point, the passage portions 160 and 161 each have a portion associated with the hot wall 102 and the cool wall 104. A separating wall 159 is further defined at this location.

Notably, the point for the cross section 4C may be selected such that the cooling load that will occur along the component is approximately halfway. As an example, the point where the two flow passages X/Y begin to exchange responsibility for the hot wall 102 and cooler wall 104 should be within 40-60% of the overall length of the airflow passages.

At the point of FIG. 4D, the triangular portions 164 and 162 again occur. However, the portion 164 that is closest to the hot wall 102 is now receiving air that had entered into the inlet 152 and had, for the most part, been associated with the cooler wall until this point. Conversely, the triangular portion 162 has air that had entered an inlet 150 and had been cooling the hot wall 102 until this point, but is now cooling the cooler wall 104.

Point E is the end point of the cooling and has portions 172 and 174 separated by wall 170. At this point, the air that had entered inlet 152 is now entirely associated with the hot wall 102, while the air from the inlet 150 is now associated entirely with the cooler wall 104.

Stated another way, a component has a body extending between two ends and a pair of cooling passages (X/Y). The body has a first hot wall 102 that will be exposed to higher temperatures than a second cooler wall 104. The cooling passages X/Y include a first passage X that is closer to the first hot wall 102 than is the second passage Y at upstream locations along a flow path. The second passage Y has upstream locations that are closer to the second cooler wall 104 than are upstream portions of the first passage X. The first and second passages X/Y cross along a length of the flow path such that downstream portions of second passage Y are closer to first wall 102 than are downstream portions of first passage X. Downstream portions of first passage X are closer to second cooler wall 104 than are downstream portions of second passage Y. The first and second passages X/Y have inlets 150/152 separated by a separating wall 154 at an upstream end. The first passage X begins to move toward second wall 104 and second passage Y begins to move toward first wall 102. The first and second passages X/Y have a first triangular location of a generally triangular shape 162/164 where each of first and second passages X/Y extend to be adjacent each of first hot wall 102 and second cooler wall 104. The first and second passages X/Y have a second triangular location of a generally triangular shape 156/158 downstream of the first triangular location. Of course, shapes other than the generally triangular shape may be utilized.

In this manner, the cooling air is used most efficiently.

Although an embodiment of this invention has been disclosed, a worker of ordinary skill in this art would recognize that certain modifications would come within the scope of this invention. For that reason, the following claims should be studied to determine the true scope and content of this invention.

1. A gas turbine engine component comprising:
a body extending between two ends and having at least two cooling passages, said body having a first wall and second wall; and
said at least two cooling passages including a first passage that is closer to said first wall than is a second of said passages at upstream locations along a flow path, and said second passage having upstream locations that are closer to said second wall than are upstream portions of said first passage and said first and second passage crossing along a length of the flow path such that downstream portions of said second passage are closer to said first wall than are downstream portions of said first passage, and downstream portions of said first passage are closer to said second wall than are downstream portions of said second passage.

2. The gas turbine engine as set forth in claim 1, wherein one of said first and second walls is exposed to hotter temperature than the other.

3. The gas turbine engine component as set forth in claim 2, wherein said first and second passages have inlets separated by a separating wall at an upstream end.

4. The gas turbine engine component as set forth in claim 3, wherein said first passage begins to move toward said second wall and said second passage begins to move toward said first wall.

5. The gas turbine engine component as set forth in claim 4, wherein said first and second passages have a first triangular location of generally triangular shapes where each of said first and second passages extend to be adjacent each of said first wall and said second wall.

6. The gas turbine engine component as set forth in claim 5, wherein said first and second passages have a second triangular location of generally triangular shapes downstream of said first triangular location.

7. The gas turbine engine component as set forth in claim 4, wherein at a downstream location said second passage extends entirely along said first wall while said first passage extends along said second wall.

8. The gas turbine engine component as set forth in claim 1, wherein at a downstream location said second passage extends entirely along said first wall while said first passage extends along said second wall.

9. The gas turbine engine component as set forth in claim 1, wherein said component includes an airfoil.

10. The gas turbine engine component as set forth in claim 9, wherein said component is a turbine blade.

11. The gas turbine engine component as set forth in claim 1, wherein said component is a blade outer air seal.

12. A gas turbine engine comprising:
a turbine section and a compressor section, one of said turbine section and said compressor section including a component; and
the component having a body extending between two ends and a pair of cooling passages, said body having a first wall and a second wall; and
said at least two cooling passages including a first passage that is closer to said first wall than is a second of said passages at upstream locations along a flow path, and said second passage having upstream locations that are closer to said second wall than are upstream portions of said first passage and said first and second passage crossing along a length of the flow path such that downstream portions of said second passage are closer to said first wall than are downstream portions of said first passage, and downstream portions of second passage are closer to said second wall than are downstream portions of said second passage.

13. The gas turbine engine as set forth in claim 12, wherein one of said first and second walls is exposed to hotter temperature than the other.

14. The gas turbine engine as set forth in claim 13, wherein said first and second passages have inlets separated by a separating wall at an upstream end.

15. The gas turbine engine as set forth in claim 14, wherein said first passage begins to move toward said second wall and said second passage begins to move toward said first wall.

16. The gas turbine engine as set forth in claim 14, wherein said first and second passages have a first triangular location of generally triangular shapes where each of said first and second passages extend to be adjacent each of said first wall and said second wall.

17. The gas turbine engine as set forth in claim 12, wherein at a downstream location said second passage extends entirely along said first wall while said first passage extends along said second wall.

18. The gas turbine engine as set forth in claim 12, wherein said component includes an airfoil.

19. The gas turbine engine as set forth in claim 18, wherein said component is a turbine blade.

20. The gas turbine engine as set forth in claim 12, wherein said component is a blade outer air seal.
